(19) United States
(12) Patent Application Publication
(10) Pub. No.: US 2007/0236961 A1
(43) Pub. Date: Oct. 11, 2007

(54) Night light

(75) Inventor: Raymond Sasson, Hauppauge, NY (US)

Correspondence Address: STROOCK & STROOCK & LAVAN LLP, 180 MAIDEN LANE, NEW YORK, NY, 10038, US

(73) Assignee: Panor Corporation

(21) Appl. No.: 11/398,448

(22) Filed: Apr. 5, 2006

(51) Int. Cl. H01R 33/00

(52) U.S. Cl. 362/641

(57) ABSTRACT

A light source is provided having a selectively positionable housing enclosing one or more LEDs. When the housing is in one position, it is preferably perpendicular to the ground, providing a light that is generally parallel to the ground with a slight amount of dispersion. When the housing is in another position, it is preferably parallel to the ground, providing a light that is primarily focused on the ground.

### BACKGROUND OF THE INVENTION

This invention relates, in general, to a light source and, in particular, a light source for illuminating an area, such as a portion of a room or hallway.

Various light sources are available to illuminate an area such as a room or hallway, according to the purpose being served. For example, light fixtures can be used to provide the desired illumination. Alternatively, a small AC/DC powered electrical light source can be used to provide a limited illumination, commonly referred to as a “night light”, which is often left on throughout the night.

Most night lights currently available in the market are stationary and do not permit manipulation of the light source to meet the individual need of the user, for example, to change the direction of the light, for example, to focus the light toward a certain direction or to alter the amount of illumination, or to change its brightness. Rather, the light source merely illuminates its vicinity according to its fixed brightness, and typically cannot be directed or the brightness altered. Therefore, most night lights currently available in the market do not provide users with many options on its use.

Additionally, most night lights currently available either use incandescent light bulbs, which are lit by heating filaments, or an LED (Light Emitting Diode) replacing an incandescent light bulb in a night light designed for an incandescent light bulb. More specifically, many night lights utilizing LEDs are designed for 5 or 7 watt bulbs, which have been modified to accept LEDs instead of the light bulbs. The lens optics, the design, etc. all follow the incandescent design. Therefore, the light emanating from the LED is not maximized.

In light of shortcomings described above, it is desirable to provide a light source such as a night light that can be manipulated, and preferably, a night light that is engineered and designed for utilizing LEDs.

### SUMMARY

Generally speaking, the present invention is directed toward a light source such as a night light that can be selectively manipulated. It is to be understood that the term “night light” includes any source of light that is not corded and can be plugged directly into an AC/DC outlet.

More specifically, in accordance with an embodiment of the invention, a light source comprises a base that can be directly connected to the power source, for example, via a power plug and a selectively pivotable housing having at least one LED mounted within, preferably covered by a clear protective lens. By providing a pivotable housing having at least one LED, the direction and the strength of the illumination can be controlled.

In accordance with one embodiment of the invention, a light source having a pivotable housing is provided.

Accordingly, it is an object of the invention to provide a night light that optimizes the illumination from an LED.

Other objects and features of the present invention will become apparent from the following detailed description, considered in conjunction with the accompanying drawing figure. It is to be understood, however, that the drawings are designed solely for the purpose of illustration and not as a definition of the limits of the invention, for which reference should be made to the appended claims.

### BRIEF DESCRIPTION OF THE FIGURES

For a fuller understanding of the invention, reference is had to the following description, taken in connection with the accompanying drawings, in which:

FIG. 1 is a perspective view of a light source constructed in accordance with an embodiment of the invention plugged into an outlet in a wall;

FIG. 2 is a perspective view of the light source of FIG. 1 in an alternate position;

FIG. 3 is a front view of a light source constructed in accordance with an embodiment of the invention;

FIG. 4 is a side view of the light source of FIG. 3; and

FIG. 5 is a side view of the light source of FIG. 3 in an alternate position.

### DETAILED DESCRIPTION

Reference is made to FIGS. 1 through 2, wherein a light source 10 constructed according to an embodiment of the invention is illustrated. As shown, light source 10 preferably comprises a housing 200 pivotally connected to a base 100 via a pivot 250 and a pivot base 150. Pivot 250 is preferably connected to housing 200 and provides selective pivoting of housing 200 about pivot base 150.

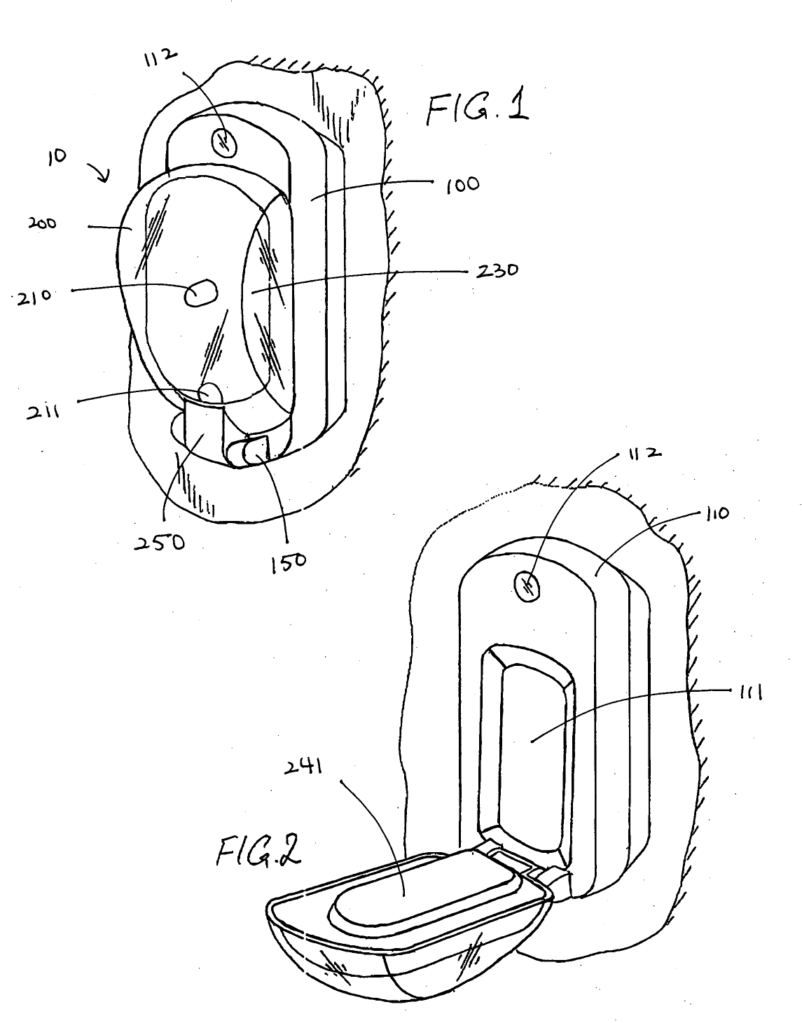

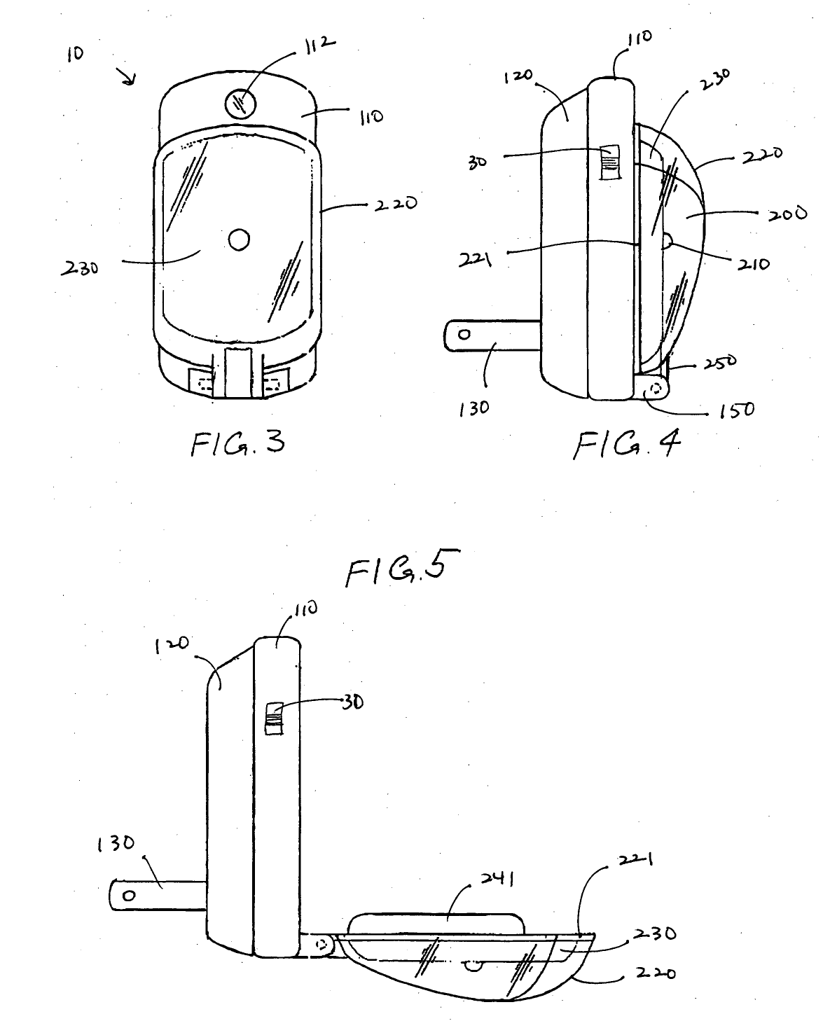

Base 100 preferably comprises a plug 130 for electrically connecting light source 10 to the power source via an outlet. As shown in FIGS. 4-5, plug 130 preferably is preferably connected to base support 120 which is connected to contact 110. Contact 110 is connected to pivot base 150, preferably toward an end of contact 110.

Referring to FIG. 1, housing 200 comprises one or more LEDs 210, 211 preferably connected to a mount 230. For example, as shown in FIG. 1, LED 210 can be positioned toward the center of mount 230. Alternatively, LED 211 can be connected to mount 230 proximate pivot 250. Most preferably, in accordance with the embodiment shown in FIG. 1, housing 200 comprises more than one LED, preferably one toward the center and one toward an end of mount 230. By providing more than one LED at varying angles, light source 10 can provide a wider range of illumination.

Housing 200 preferably encloses LEDs 210, 211, which preferably provide substantially focused beams of light compared to light bulbs, and mount 230 between a shell 220 and backing 221. Housing 200 can comprise a plurality of LEDs, for example, two LEDs as shown in FIG. 1 or a single LED as shown in FIG. 3. By providing a single LED 210 proximate the center of mount 230, in accordance with the embodiment shown in FIG. 3, a very focused light is provided, substantially parallel to the ground when housing 200 is in the upward position as shown in FIG. 3. Alternatively, when housing 200 is in the downward position as shown in FIG. 5, LED 210 preferably shines a light substantially toward the ground.

Additionally, referring to FIG. 1, housing 200 can comprise a plurality of LEDs. For example, LED 211 can be located proximate pivot 250 in addition to LED 210 proximate the center of mount 230. Accordingly, light source 10 can provide increased illumination and provide light in two different directions, one at an angle from the ground, and one substantially parallel to the ground, when housing 200 is in the upward position.

As shown in FIGS. 1, 4-5, an embodiment of shell 220 comprises a greater curvature toward one end of shell 220 and a smaller curvature toward another end of shell 220. Preferably, the smaller curvature is proximate pivot 250, and the greater curvature is the end opposite pivot 250. In accordance with a preferred embodiment of the invention, shell 220 comprises a shape similar to a headlight of an automobile, more specifically, wherein the curvature of the top of shell 220 is greater than the curvature toward the bottom of shell 220. By providing a greater curvature toward the top and a smaller curvature toward the bottom, housing 200, when flushed against base 100, provides a dispersed light upward and a more concentrated light parallel to the ground and downward, thereby better lighting the floor than a light that disperses light equally.

More preferably, backing 221 comprises a material that prevents light from emanating through. Therefore, when housing 200 is pivoted outward from base 100, for example, toward the floor as shown in FIG. 5, wherein housing 200 is substantially parallel to the ground, backing 221 prevents light from emanating upward. Hence, because outlets are typically relatively close to the ground, backing 221 prevents light from illuminating the area. Rather, light source 10 preferably illuminates a limited area downward from the outlet, more preferably concentrated on the floor. Therefore, when housing 200 is in the downward position, the area, such as a hallway or a room, can remain dark, with only parts of the floor and its vicinity illuminated, thus providing safety while not being overwhelmingly bright to the eye. Alternatively, if light source 10 is rotated 180 degrees from the example shown in FIG. 1 prior to being plugged into an outlet on a wall, pivoting housing 200 away from base 100 can provide a more dispersed illumination into the area.

Referring to FIG. 4, when housing 200 is flushed against base 100, contact 110 can engage backing 221 of housing 200. More preferably, as shown in FIG. 2, contact 110 comprises a recess 111 which engages a protrusion 241 of housing 200. This relationship between recess 111 and protrusion 241 can preferably permit LEDs 210, 211 to be positioned flushed with backing 221 while helping to reduce the depth of light source 10, to provide a relatively small and compact size. Furthermore, protrusion 241 can be constructed and arranged to house the circuitry or other elements necessary related to LEDs 210, 211, in housing 200. Additionally, protrusion 241 can preferably facilitate improvements, additional features and enhancements of light source 10 by providing a space in which corresponding electronic components and/or other necessary material can be housed.

In accordance with the embodiments of the invention as shown in FIGS. 1-3, light source 10 can comprise a sensor 20, which provides automation of light source 10. Preferably, sensor 20 detects light or the absence of light, once a predetermined threshold darkness is detected by sensor 20, light source 10 is activated, thereby lighting LEDs 210, 211. Accordingly, light source 20 can be left plugged into the outlet without requiring a person to manually turn it on or off, or plug it in or remove it from the outlet. Additionally, as shown in FIGS. 4-5, light source 10 can include a dimmer 30 for controlling the brightness of LED 210, 211. Preferably, dimmer 30 is located on a side of base 100.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, housing 200 can comprise a different shape, for example, it can be rectangular, round, etc., without deviating from the scope of the invention as a matter of application specific to design choice. Additionally, other alterations can be made, as a way of non-limiting example, increasing the number of LEDs, altering the transparency of shell 220, depending on the desired illumination, as a matter of application specific to design choice, without deviating from the scope of the invention. Alternatively, backing 221 can be translucent, to provide a glowing appearance or slight illumination of housing 200, without deviating from the scope of the invention as a matter of application specific to design choice. Furthermore, whereas sensor 20 is illustrated to provide automatic activation and termination of light source 10, a manual switch may be provided as a matter of application specific to design choice without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A light source comprising
a base comprising a power plug; and
a housing selectively pivotably mounted to the base, the housing comprising at least one LED, whereby pivoting of the housing permits adjustment of the direction of the light emitted by each LED; and

2. The light source of claim 1, comprising two LEDs.

3. The light source of claim 1, wherein the housing is formed at least in part from transparent material.

4. The light source of claim 1, wherein the housing pivots away from the base.

5. The light source of claim 1, wherein the housing pivots toward the ground.

6. The light source of claim 1, wherein the housing comprises a backing constructed and arranged to prevent light from being transmitted therethrough.

7. A light source comprising a base and a housing, wherein the housing comprises at least one LED and the housing can be selectively positioned in at least two positions.

8. The light source of claim 7, wherein one of the positions of the housing is substantially perpendicular to the ground.

9. The light source of claim 7, wherein one of the positions of the housing is substantially parallel to the ground.

10. The light source of claim 7, wherein the light source comprises a night light.

11. The light source of claim 7 comprising a dimmer switch.

12. The light source of claim 7 comprising a light sensor.
